(19) United States
(12) Patent Application Publication
(10) Pub. No.: US 2009/0222338 A1
(43) Pub. Date: Sep. 3, 2009

(54) Monitoring and Rewards Methodologies for "Green" Use of Vehicles

(76) Inventors: Rick A. Hamilton, II, Charlottesville, VA (US); Paul A. Moskowitz, Yorktown Heights, NY (US); Brian Marshall O'Connell, Cary, NC (US); Clifford Alan Pickover, Yorktown Heights, NY (US); Keith Raymond Walker, Austin, TX (US)

Correspondence Address: WHITHAM, CURTIS,CHRISTOFFERSON & COOK, P.C. (IBM), 11491 SUNSET HILLS ROAD, SUITE 340, RESTON, VA, 20190, US

(21) Appl. No.: 12/040,978

(22) Filed: Mar. 3, 2008

(51) Int. Cl. G06Q 30/00

(52) U.S. Cl. 705/14

(57) ABSTRACT

Energy-efficiency related data corresponding to dynamic energy-efficiency related operational parameters of a vehicle are collected from in-vehicle sensors and energy-efficiency parameters may be computed therefrom. The energy efficiency-related parameters and energy-efficiency parameters are then transmitted either directly of through a wireless and/or network link(s) to a station at which a transaction with a vehicle operator may be performed. An incentive based on efficiency of vehicle operation is computed and awarded to provide feedback to a vehicle operator to provide information concerning efficient vehicle operation and to encourage efficient and environmentally responsible vehicle operation. Both energy efficiency and environmental effects may be displayed at the station or substantially continuously and in substantially real time within the vehicle.

### BACKGROUND OF THE INVENTION

1. Field of the Invention

The present invention generally relates to monitoring of the condition and use of vehicles and providing incentives for energy-efficient operation and/or environmentally friendly operator behaviors and, more particularly, to systems and methods for exchange of information concerning vehicle operation and computing rewards at a station where a transaction is conducted with a vehicle operator.

2. Description of the Prior Art

Service providers, public agencies and individual members of the public all have an interest in encouraging safe and energy-efficient use of motor vehicles; the latter sometimes being referred to as “green” in reference to minimizing environmental effects of vehicle use. Such environmental effects may be considered as generally corresponding to consumption of fuels, lubricants, coolants, tires and the like. Consumption of such materials is generally associated with the release of pollutants into the environment such as by the burning of fossil fuels in internal combustion engines which releases carbon dioxide and some organic chemicals into the atmosphere. Speed and acceleration are principal factors which may increase fuel consumption and corresponding generation of gases released into the environment. Vehicle maintenance is often a significant factor in fuel consumption as well as often involving removal and replacement of lubricants and coolants which may or may not be recycled to avoid release into the environment. Refrigerants used in air-conditioning systems of vehicles have also been a significant source of environmental pollution in the past.

However, motor vehicles represent not only a convenience but a necessity to users thereof and are likely to be operated in a manner which maximizes utility and convenience to operators of such vehicles. For example, the convenience to a particular vehicle operator is likely to cause operation of the vehicle at a higher speed and with greater acceleration/deceleration than necessary and which are certainly not generally optimal for efficient energy use. Moreover, many features such as electrically operated windows and higher engine power is often provided in current vehicle designs which principally function as conveniences while being of substantial weight that negatively impacts fuel efficiency but are often demanded by vehicle users. Alteration of such preferences and behaviors of vehicle users has proven difficult since environmentally responsible vehicle acquisition and operation is often contrary to the convenience and/or preferences of the vehicle operator. Further, any previously available attempts to provide incentives in regard to environmental costs of vehicle operation or which may arise out of a person's perceived social responsibility have not generally been successful since they have not been linked to vehicle operation costs sufficiently closely and comparative costs may not be quantitatively understood with sufficient accuracy by most vehicle operators. That is, while there is a relationship between economical operation of a vehicle and environmental impact of vehicle operation, vehicle operators have only the most rudimentary and qualitative understanding of relatively few aspects of the impact of vehicle operation on the former and very little awareness of the impact on the latter. At the same time, the general public is not willing, at the present time, to bear the cost of having instrumentation provided in a vehicle to provide such information without an assurance of a return on such an investment.

### SUMMARY OF THE INVENTION

It is therefore an object of the present invention to provide a system and methodology to provide a system which will provide incentives as feedback to vehicle operators accurately scaled to the environmental costs of numerous aspects of vehicle operation and maintenance.

It is another object of the invention to increase incentives to vehicle operators for environmentally responsible vehicle operation beyond those arising solely from improved economy of vehicle operation.

It is yet another object of the invention to provide a system which provides feedback to operators of vehicles to increase awareness of aspects of economical and environmentally responsible vehicle operation, particularly in a quantitative manner.

In order to accomplish these and other objects of the invention, a method and a computer readable medium for causing a processor to perform a method is provided of encouraging energy-efficient and environmentally responsible operation of vehicles including steps of collecting data from in-vehicle sensors regarding dynamic energy-efficiency related parameters of vehicle operation, calculating dynamic energy-efficiency parameters from the data collected, transmitting selected portions of the data collected and calculated to a station, computing an incentive based on data and parameters transmitted, and displaying/awarding an incentive.

In accordance with another aspect of the invention, a system for informing vehicle operators of vehicle operation efficiency is provided comprising a vehicle including sensors for measuring dynamic energy-efficiency related parameters of operation of the vehicle, a processor for computing energy-efficiency parameters from said energy-efficiency related parameters, and an arrangement for communicating data from said sensors and said processor externally of said vehicle, an arrangement for receiving data communicated to a station, and an arrangement for computing and accumulating or awarding incentives based on at least a portion of said data.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a high-level block diagram of a preferred embodiment of the invention,

FIG. 2 is a flow chart illustrating basic steps (including optional steps) performed in the practice of the preferred embodiment of the invention,

FIG. 3 is a block diagram representing a network to which the invention is connected and indicating further features and effects which can be achieved as perfecting features of the invention

### DETAILED DESCRIPTION OF A PREFERRED EMBODIMENT OF THE INVENTION

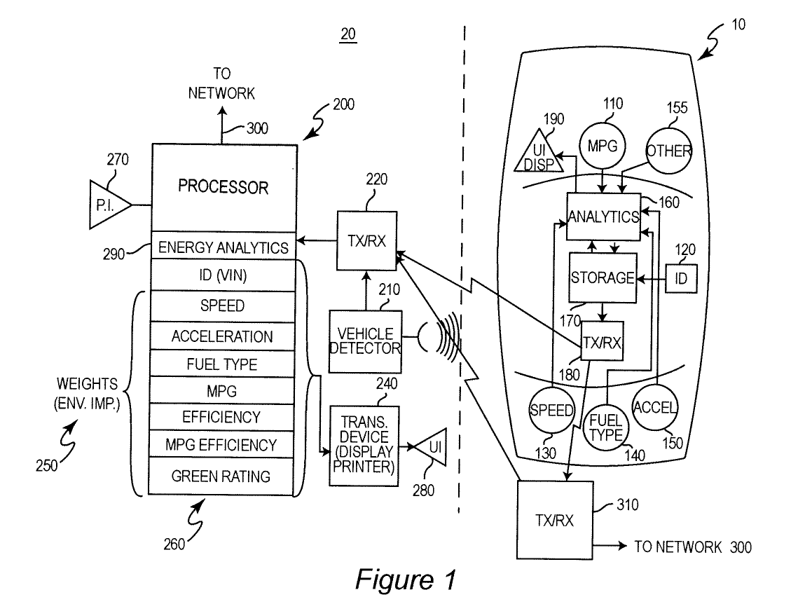

Referring now to the drawings, and more particularly to FIG. 1, there is shown a high-level block diagram of a preferred embodiment of the invention. It will be appreciated by those skilled in the art that, at the level of abstraction of FIG. 1, the Figure also may be regarded as a data flow diagram illustrating the collection, communication and processing of data in accordance with the system and methodology of the invention. It will also be appreciated that the association of various elements of the invention with either the vehicle 10 or station 20 (which is intended to be collectively representative of a fuel dispenser, toll booth, car wash or any other device or location where a transaction with the vehicle operator can be carried out) represents a preferred allocation between them which is not at all critical to the successful practice of the invention but which is preferred for the purpose of leveraging existing infrastructure to the extent possible in order to minimize the expense of implementation of the invention.

As illustrated in FIG. 1, the structure for implementation of the system is preferably divided between a vehicle 10 and a station 20. At the present state of the art of vehicle instrumentation, vehicle 10 will generally include a processor and numerous sensors for detecting current, dynamic vehicle operating or usage conditions, correlation of such conditions and storage of sensor outputs, both instantaneous and over time such as over an operator designated trip and for a short interval that can be of forensic value in accident investigation. In many cases, such sensor outputs may be accessed by the vehicle operator in real time. Thus, source of information such as efficiency/miles per gallon (MPG) sensor or calculator 110, a source of vehicle identity information 120, speed sensor 130, fuel type sensor 140 (at least for vehicles capable of using alternative fuels) and acceleration sensor 150 will be present in most currently available vehicles. Sensors 155 for other conditions such as tire pressure and/or pollution control apparatus may also be provided, either as vehicle features or for practice of the invention as perfecting features thereof. In any case, the sensed usage information or data includes information gathered dynamically during actual use or operation of a vehicle and include real, actual operating parameters of the individual vehicle.

The processor(s) generally present in currently available vehicles will typically be underutilized and are suitable for providing analytics in accordance with the invention if not already programmed to compute analytical information which the invention utilizes, as depicted at analytics processor 160. If not already present in a given vehicle, such a processor may be provided and suitably programmed at relatively low cost since required computing power for the practice of the invention is relatively small and response speed is not critical. The processor 160 is also in bidirectional communication with storage 170 which is preferably of a non-volatile type such that data is not lost if power is interrupted. A transmitter and receiver arrangement 180, details of which are not important to the successful practice of the invention, is also preferably provided. All of these elements will be described in greater detail below in regard to functions preferably provided for practice of the invention in accordance with the preferred embodiment thereof. However, in many cases, no modification of the sensors will be necessary for successful practice of the invention and only minor alteration of programming of the processor currently provided in vehicles will be desirable.

In regard to station 20, it is to be understood that some redundancy over the structure illustrated as being associated with vehicle 10 is desirable in order to have the system and methodology in accordance with the invention be more universally applicable to vehicles which may not have all of the sensors and analytical processing illustrated in FIG. 1 available. For example, a vehicle may have a fuel flow rate sensor and a speed sensor or odometer and only store vehicle operational data for a very short period of time to support accident investigation, as alluded to above although some additional supplementary storage may be available in connection with the in-vehicle processor. Thus, even if only such minimal information is available from the vehicle, some of the analytical processing and data storage preferably performed in the vehicle on a cumulative basis can be performed at station 20 or at processors connected therewith, such as by a network as indicated by reference numeral 300. It is also possible, to accommodate vehicles with only small storage capability for storing dynamic operating condition information, to collect information from vehicles periodically such as by a roadside transmitter/receiver 310 which may be a wireless communication facility such as a cellular telephone relay or a dedicated transmitter/receiver (Tx/Rx) arrangement or other similar infrastructure to provide either a periodic or more-or-less continuous collection of dynamic operating conditions or representative “snapshots” of operating conditions which the vehicle is able to store. Such collected information may be relayed to stations either by direct links, possibly through other Tx/Rx arrangements 310, or over network 300 to one or more stations 20.

Station 20 preferably includes one or more transmitter/receiver (Tx/Rx) arrangements 220 which are preferably provided such that at least one will be compatible with transmitter/receiver 180, allowing different arrangements and data transmission protocols to be used among, for example, different vehicle manufacturers and which may include a link compatible with wireless communication devices such as cellular telephones, wireless messaging systems or other transmission links such as Bluetooth™ or so-called near-field communication systems which may be available through such devices. The communication link between transmitter/receiver (Tx/Rx) arrangements 180 and 220 may also be as simple as a low-frequency inductive link and need not be bi-directional (e.g. bi-directional links are desirable for such functions as resetting memory 170 following transmission of its contents but such functions may be otherwise achieved) since the invention may be successfully practiced in accordance with its basic principles with only a transmitter in the vehicle 10 and a receiver in the station 20.

It may also be found desirable to provide a vehicle detector 210 to control operation of the transmitter/receiver arrangement 220 although such a perfecting feature of the invention is not necessary to the successful practice of the invention in accordance with its most basic principles. Such a vehicle detector could be advantageous, however, to allow transmissions to or from different vehicles to be differentiated is some applications such as fuel dispensing installations where several fuel pumps (each corresponding to a separate station 20) may be located in close proximity to one another and within range of TxRx 180 of a given vehicle at a given station. A structure similar to a vehicle detector could also be provided at Tx/Rx 180 to indicate the presence of a station or other device or installation (e.g. a location accessible for wireless messaging) that can provide for downloading of information from a vehicle at times other than when the vehicle is proximate to a station such as Tx/RX 310, traffic monitors along highways or, especially, toll roads.

The basic function of processor 200 is to process data (which may include all or only selected portions of the dynamic operation condition data derived from sensors and/or none, all or only selected ones of the operational parameters computed from the sensor data) derived through the communication link between TxRx 180 and TxRx 220 (and possibly one or more Tx/RX arrangements 310) in order to monitor energy-efficient and environmentally responsible operation of motor vehicles through vehicle parameter sensors 120-155 that monitor the dynamic operation and operational condition of motor vehicles and support provision of incentives and information as feedback to vehicle operators that encourage efficiency and environmental responsibility. That is, by enabling vehicle operators to see immediate feedback of quantitatively accurate information, particularly in the form of immediate monetary awards, discounts or goods, vehicle operators may be encouraged to adopt energy-efficient and environmentally responsible methods for operation of vehicles. Moreover, vehicle operators may thus learn of operating techniques of which they were unaware in order to avoid economically or environmentally detrimental practices or to more consistently practice economically and environmentally sound practices. As a perfecting feature of the invention, such information may also be further processed and/or distributed in order to adaptively and/or cumulatively acquire information such that environmental impact of vehicles and their operation can be more accurately assessed.

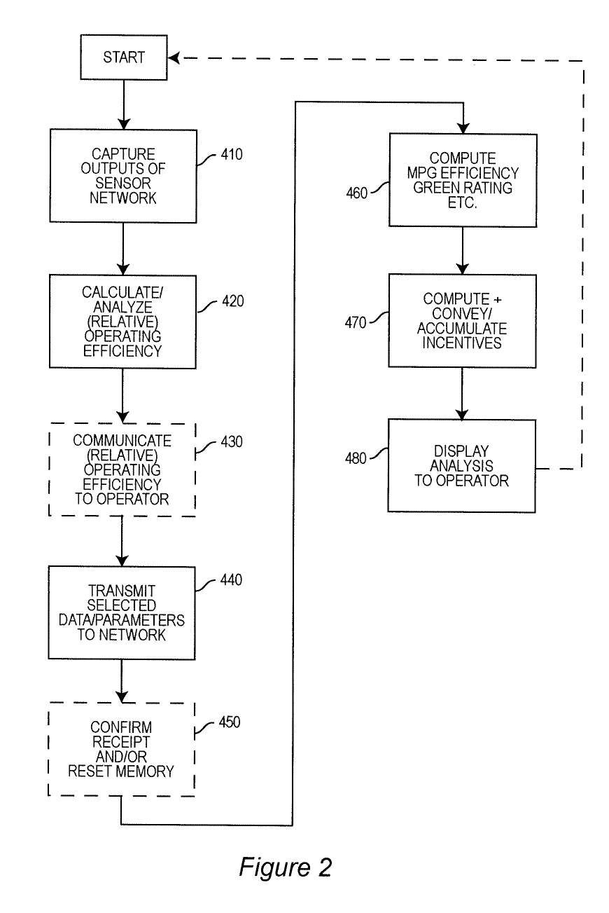

Referring now to FIG. 2 as well as FIG. 1, the operations preferably performed to achieve such effects will now be described. In general, when a vehicle operator activates a vehicle for operation, vehicle condition and operation sensors 120-155 and processor 160 will be activated simultaneously or shortly thereafter. When such sensors are activated, data is captured detailing energy and resource efficiency of a vehicle as depicted at step 410 of FIG. 2. From the captured data, analytic processor 160 or 200/290 determines the operating or relative operating efficiency of the vehicle and, in so doing, may include consideration of the make, model, etc. of the vehicle as well as the cumulative or past performance of the particular vehicle, using data from vehicle identification data source 120, as depicted at step 420. This information may be optionally communicated to the vehicle operator in substantially real time using, for example, display 190 or display 280 at station 200 as depicted in step 430. (Relative operating efficiency is preferably the actual efficiency achieved as compared with, for example, the efficiency or efficiency range expected from or averaged over the same or possibly other vehicle type (e.g. so-called “fleet efficiency”). It is preferred to provide the option of displaying a comparison of the efficiency to other vehicles of the same type or provide an indication of the efficiency that could be achieved with another vehicle type, a comparison with all vehicle operators, etc.) The analytic information thus developed by processor 160 is then cumulatively stored in (preferably non-volatile) memory 170. Such communication to the vehicle operator may include, for example, a tentative scoring to indicate overall energy efficiency and/or environmental impact or particular aspects of current vehicle operations which are least energy-efficient or environmentally responsible such as excessive speed variation (e.g. excessive acceleration and deceleration) or under-inflated tires.

When the vehicle is in a location such as a station 20 or other location where information can be downloaded through, for example, a wireless messaging link or collection service accessible through an IP address, operating efficiency, as analytically computed in the vehicle, or sensor data (either as collected or as accumulated or averaged, with or without outlier suppression or removal) is downloaded for processing either through network 300 or locally at a station 20, as depicted in step 440. It should be noted that collection of such data as it becomes available even if the vehicle is not at a station 20 reduces memory requirements in the vehicle as well as the need for rapid response thereto. Confirmation of receipt of such information, as depicted at step 450, is not necessary but is preferred to prevent redundant (e.g. covering overlapping periods of vehicle operation) information from being processed. Confirmation of data receipt also allows storage 170 to be reset or for data to be tagged therein to avoid loss of data, which may reduce storage capacity requirements while improving the reliability of data used for incentive computation. As illustrated at step 460, efficiency parameters may be computed; which computation may use different formulas and include other parameters than done at step 420 is then performed on the transmitted data which may selectively include less than all sensor data and/or previously calculated parameters. An environmental effect rating which may be either quantitative (e.g. a percentage of operating behaviors and conditions which are substantially optimally responsible) or qualitative (e.g. expressed as a color shade ranging from “green” to some color psychologically perceived as contrary thereto) is also preferably computed and may be derived differently (e.g. using different weights or combination of parameters) than efficiency parameters (e.g. to include consideration of disposal costs of lubricants, tires, etc.). Finally, as depicted at step 470, incentives in the form of toll discounts, fuel discounts, fuel tax incentives or other cash or non-cash incentives (e.g. coupons redeemable for vehicle or travel related services such as car washes, oil changes, tune-ups and the like) are computed and displayed and/or dispensed, preferably in connection with a display indicating areas of inefficiency in vehicle operations which would enhance the value of such incentives if observed by the vehicle operator, using a display and/or printer as depicted at 240 of FIG. 1.

As alluded to above, sensor networks suitable for practice of the invention are often included in commercially available vehicles at the present time as part of an in-vehicle monitoring system. Suitable sensor systems are disclosed in U.S. Pat. Nos. 6,339,736 and 6,330,499, both of which are hereby incorporated by reference in their entirety. Such sensors should preferably include sensors for detecting speed, acceleration, mileage (e.g. miles per gallon) and fuel type. Other sensors such as engine temperature, tire pressure and temperature, axle loadings and the like may be included from which conditions or parameters affecting efficiency may be directly measured or developed through appropriate analytic processing by processor 160. For example, rate of tire pressure change (e.g. increase) as a function of speed and possibly including consideration of axle loading or engine temperature relative to ambient air temperature and pressure and/or road grade could indicate improper wheel alignment or tire scrub which can affect both operating efficiency and excessive wear on numerous parts of the vehicle. In general, such sensors in combination with processor 160 and memory 170 should preferably be capable of reporting maximum, minimum and average (e.g. between data downloads to stations 20 or network 300) values of respective parameters, and severity and duration of periods during which such parameters exceed values where efficiency and/or environmental impact is aggravated. The fuel type sensor 140 should preferably accommodate the different types of fuel (e.g. octane rating, ethanol content, diesel, natural gas or other alternative fuel and the like) which may be used in a particular vehicle and which may be more or less detrimental to the environment as may be detected by a sensor, specified by a user or registered by a transmission from a fuel dispensing pump and should preferably accommodate computation of mixtures of fuels, prevent mixture of incompatible fuels or prevent or warn against introduction of improper fuels into the vehicle.

The sensor data may be conveyed to an in-vehicle energy analytic computing device 160 and the resulting set of data transmitted by a telecommunications device or over the link between TxRx arrangements 180 and 220 (and/or 310) or simply recorded and stored and communicated to the in-vehicle network or vehicle data bus. The vehicle data bus, generally depicted in FIG. 1 by connections to processor 160 may be of any of several standards such as the SAE J1850 bus found in many vehicles of North American manufacture or the Controller Area Network (CAN) bus found in European-manufactured vehicles.

The energy analytic system calculates the operating efficiency of a vehicle from vehicle characteristics (e.g. in accordance with vehicle types as indicated by vehicle ID information source 120 or as accumulated based on the individual vehicle or the vehicle type) and data gathered by the sensor network comprising sensors 120-155. Calculations and formulas may vary widely based on the amount of data available or particular embodiments or applications of the invention but it is preferred that embodiments of the invention should include a calculation of a “normalized” miles per gallon or MPH efficiency (which may vary from raw MPG sensor data) and speed/acceleration. The “normalized” MPG or MPG efficiency is derived through a comparison of the actual instantaneous or average MPG and the expected MPG for the vehicle type (which may be the so-called EPA rating or fleet efficiency or developed empirically over numerous instances of the vehicle type or a combination of both). The expected MPG may also be situational as when accelerating or traversing roads with frequent grade changes and may be expressed as a range which specifies thresholds for “normal” operation and may also be adjusted to account for expected changes of efficiency as a vehicle ages. The determination of “normalized MPG” or MPG efficiency may include a determination of qualitative “poor efficiency” by comparison with threshold values associated with vehicle type and then invoking diagnostics including consideration of speed and acceleration or other sensor outputs to determine a root or principal cause of the out-of-range efficiency which may then be communicated to the vehicle operator in real time and/or accumulated for further notification to the vehicle operator as incentives are dispensed or withheld at station 20. In this regard, it may be desirable, depending on the stored record of poor efficiency, to expunge some or all calculations which result in out-of-range efficiency, depending on frequency or circumstances. For example, if a particular maneuver is determined or indicated to be forced by a need for evasive action (e.g. as might be determined by a proximity sensor among sensors 155), a particular poor efficiency determination may be expunged. On the other hand, if poor efficiency is brief but frequently repeated while proximity of another vehicle is reported, such conditions may be indicative of aggressive driving and a greater weight or increased count applied to periods of vehicle operation determined to be of low efficiency which also correlate with undesirable driving habits.

While environmental impact of vehicle operation will often generally correspond to efficiency (as distinct from MPG efficiency which considers the expected efficiency and efficiency range for the particular vehicle type), there may be additional factors that may be desirable to consider and it is therefore preferred to also compute environmental impact separately or somewhat differently from efficiency. For example, modes of operation or vehicle conditions that can be expected to result in more rapid lubricant or coolant life exhaustion, deterioration of emission control system condition, engine wear, or tire wear and the like all have negative impact on the environment, even when recycling of tires or fluids is scrupulously followed. Therefore, any conditions which can be deduced from the outputs of the sensor network employed may be included in the calculation. Different weights 250 may be assigned to each such environmental impact included in the calculation (e.g. disposal or recycling of tires may have a greater negative environmental impact than recycling of motor oil, ethanol or synthetic oils may have a different environmental impact than refined petroleum fuels or lubricants which, in turn, may vary by fuel type and percentage content of mixtures) including MPG, speed, acceleration, fuel type, etc.). The environmental impact of manufacture of replacement parts or materials may also be considered in such weighting or calculation. The calculation of incentives to be awarded may also include respective weights for different analytically processed quantities which may be combined, as desired, in regard to particular incentives. For example, MPG efficiency may be the sole or predominant criterion for incentives awarded in connection with dispensing of fuels, while computations based on speed and acceleration may predominate or be accorded greater weight in regard to incentives connected with tolls, while calculations based on efficiency related to vehicle condition may predominate or be accorded a greater weight for other goods or services.

As noted above, it is preferred that some redundancy exist between the analytics computed in the vehicle and those computed locally to station 20 but precise duplication is not necessary or even desirable since the functions and use of the information so computed is different between the vehicle 10 and the station 20. Specifically, information provided to a vehicle operator while the vehicle is being operated has essentially the function of providing prompts or suggestions to the operator about ways the operation of the vehicle could be improved for general overall efficiency and which may, incidentally, tend to maximize incentives but not necessarily lead to specific and quantitative expectations of the incentives which may be eventually conveyed. Conversely, it is contemplated that, while incentives given will lead to improved behaviors on the part of vehicle operators, the computation of specific incentives conveyed will accommodate a further purpose of enhancing and augmenting the business interests of particular stations which may be very different. Therefore, it is expected that some degree of uniformity will exist for in-vehicle efficiency computations (while a “green” rating may or may not be included) while computations for respective stations 20 may be freely varied.

The energy analytic processing systems 160, 220 in a vehicle or station, respectively, store the operating efficiency analytics in respective storage systems 170, 260. The stored analytics may then be accessed through a user interface (UI) component 190 (in-vehicle) or 280 (at a station 20) or through a provider interface (PI) component 270 which will be described below. Additionally, the stored analytics may be cleared by an energy analytic component (e.g. 290) provided in processors 160, 200 or through instructions from service providers, agencies and the like.

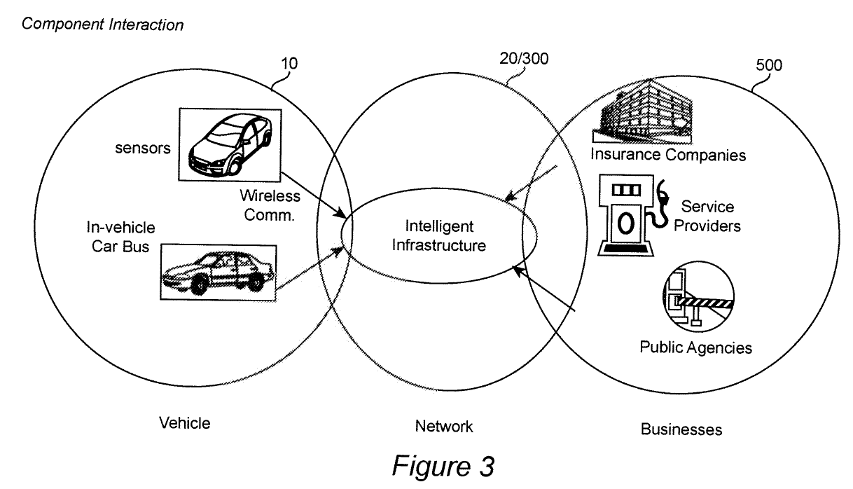

A user interface is preferably provided to view present and previous energy analytics, either from the sensors in substantially real time or from storage or a combination thereof to communicate efficiency information and, preferably the root cause(s) of poor efficiency, such a speed and/or acceleration/deceleration tendencies. The provider interface should permit service providers, insurance companies (e.g. for more accurate projection of risks), public agencies (e.g. for monitoring changes in driving habits, particularly as may be induced by use of the invention, possibly in accordance with demographic patterns), vehicle rental companies and networks of stations (e.g. toll booths for different roads and fuel vendor chains or franchises) to access energy analytics in order to develop policies regarding the computation of incentives which may then be implemented in and possibly coordinated between stations 20 the network 300 as depicted in FIG. 1 thus is made capable of functioning as an intelligent infrastructure connecting businesses 500 and individual vehicles 10 for collection of data, as shown in FIG. 3 by which business service compatibility and efficiency may be improved while tending to improve the environmental responsibility of vehicle operation by individual operators.

In view of the foregoing, it is seen that the invention provides a system by which incentives closely linked to environmentally responsible and efficient vehicle operation may be provided while also providing for data collection which can improve the efficiency with which travel-related businesses are conducted as well as providing more accurate assessment of environmental impact of vehicle use. The system in accordance with the invention can be implemented at little cost by leveraging existing infrastructure; an example of which is provided in the following exemplary scenario.

When a driver approaches a toll booth, a lighted sign at the toll booth communicates to the driver a message such as “Green:Good” and may or may not adjust a toll, register a credit toward a future toll (e.g. such that every third, fourth, fifth, etc. toll may be free, depending on consistency of “good” operations such as consistency of speed and non-aggressive driving) or dispense a coupon redeemable for goods or services (e.g. at a facility along the toll road). If such an incentive is delivered or accumulated, it is done substantially instantaneously and in close relationship to the operators driving performance to best encourage association of good driving habits with such incentives while giving prompts as to how such driving habits may be improved and incentives may be increased. The system is able to ascertain that the driver has been operating the vehicle efficiently based on the following exemplary infrastructure enablers such as traffic detectors including automatic toll payment arrangements such as E-Z Pass™ which relies on point-to-point radio frequency identification (RFID) to monitor progress of a vehicle (e.g. speed variation, average speed, rest stops and the like) coupled with fuel consumption information either estimated or captured from the vehicle sensor network or “black-box” couple to the auto-bus in the vehicle using Bluetooth™ or another wireless communication arrangement. It can be readily appreciated that a similar scenario can be extended to a fuel dispensing installation where cost and/or tax discounts may be provided as incentives for improvement of driving habits with or without additional incentives such as coupons or discount on other purchases which may benefit business interest at related stations or other research or marketing purposes.

While the invention has been described in terms of a single preferred embodiment, those skilled in the art will recognize that the invention can be practiced with modification within the spirit and scope of the appended claims.

1. A method of encouraging energy-efficient and environmentally sound operation of vehicles including steps of
collecting data from in-vehicle sensors regarding dynamic energy-efficiency related parameters of vehicle operation,
calculating dynamic energy-efficiency parameters from said data collected in said collecting step,
transmitting selected portions of said data collected in said collecting step and selected ones of said dynamic energy-efficiency parameters to a station,
computing an incentive based on data and parameters transmitted in said transmitting step, and
displaying or awarding a said incentive in connection with a transaction at a station.

2. A method as recited in claim 1 wherein said collecting step is performed at a station where a transaction with a vehicle operator is performed.

3. A method as recited in claim 1 wherein said collecting step is performed periodically during vehicle operation.

4. A method as recited in claim 3 wherein said collecting step is performed through a wireless communication facility.

5. A method as recited in claim 1 including a further step of computing normalized energy efficiency for a vehicle.

6. A method as recited in claim 5 including a further step of displaying said normalized energy efficiency to an operator while operating said vehicle.

7. A method as recited in claim 5 including a further step of displaying said normalized energy efficiency to a vehicle operator at a station.

8. A method as recited in claim 1 including a further step of computing an environmental effect rating for vehicle operation.

9. A method as recited in claim 8 including a further step of displaying said environmental effect rating to an operator while operating said vehicle.

10. A method as recited in claim 8 including a further step of displaying said environmental effect rating to a vehicle operator at a station.

11. A method as recited in claim 1 wherein said computing step includes a step of assigning weights to said energy-efficiency related parameters and/or energy efficiency parameters.

12. A method as recited in claim 11 wherein combinations of said energy-efficiency related parameters and said energy efficiency parameters used in said computing step are selected in accordance with a type of said incentive to be awarded.

13. A method as recited in claim 12, wherein weight applied to said energy-efficiency related parameters and said energy efficiency parameters selected and used in said computing step are selected in accordance with a type of said incentive to be awarded.

14. A system for informing vehicle operators of vehicle operation efficiency, said system comprising
a vehicle, said vehicle including
sensors for measuring dynamic energy-efficiency related parameters of operation of said vehicle,
a processor for computing energy-efficiency parameters from said energy-efficiency related parameters, and
means for communicating data from said sensors and said processor externally of said vehicle,
a means for receiving said data communicated to a station, and
means for computing and accumulating or awarding incentives based on at least a portion of said data.

15. A system as recited in claim 14 wherein said means for receiving includes
means for transmitting said energy-efficiency related parameters and said energy-efficiency parameters to a station.

16. A system as recited in claim 15, wherein said station includes means for displaying said energy-efficiency related parameters and energy efficiency parameters to an operator of said vehicle.

17. A system as recited in claim 14, wherein said vehicle further includes means for displaying said energy-efficiency related parameters and energy efficiency parameters to an operator of said vehicle.

18. A system as recited in claim 14 wherein said means for computing further includes means for computing an environmental effect rating.

19. A system as recited in claim 14 wherein said means for computing further includes means for computing a normalized efficiency rating.

20. A computer readable medium for providing program signals to a processor, said program signals, when run on said processor, causing said processor to perform steps of
collecting data from in-vehicle sensors regarding dynamic energy-efficiency related parameters of vehicle operation,
calculating dynamic energy-efficiency parameters from said data collected in said collecting step,
transmitting selected portions of said data collected in said collecting and selected ones of said dynamic energy-efficiency parameters,
computing an incentive based on data and parameters transmitted in said transmitting step, and
awarding said incentive.
